(19) United States
(12) Patent Application Publication
(10) Pub. No.: US 2015/0019249 A1
(43) Pub. Date: Jan. 15, 2015

(54) METHODS AND SYSTEMS FOR QUANTIFICATION OF PRACTITIONER MEDICAL SERVICES PRODUCTION INPUTS

(71) Applicant: Duane Brookhart, Montgomery, AL (US)

(72) Inventor: Duane Brookhart, Montgomery, AL (US)

(21) Appl. No.: 14/332,189

(22) Filed: Jul. 15, 2014

Related U.S. Application Data
(60) Provisional application No. 61/846,377, filed on Jul. 15, 2013.

(51) Int. Cl. G06Q 50/22; G06Q 40/00

(52) U.S. Cl. CPC G06Q 50/22; G06Q 40/12
USPC 705/2

(57) ABSTRACT

This disclosure provides a methods and systems for quantification of medical services production that recognizes both Independent Production Inputs and Collaborative Production Inputs for multiple Practitioner efforts. Inputs are represented in terms of standardized Relative Value Units, with Practitioner production contributions determined by Enterprise-determined Production Allocation appropriate to Service, Location of Service, Practitioner, Collaborator, Payer or other factors. The results of these processes are represented in various Reports, Tables and Graphs 50. The quantification of Practitioner medical services production inputs provides improved determination of inputs for multiple Practitioner medical services production.

### CLAIM OF PRIORITY

The application claims priority to and the benefit of U.S. Provisional Application No. 61/846,377, filed Jul. 15, 2013, which is incorporated by reference herein in its entirety.

### TECHNICAL FIELD

The aspects disclosed herein relate to methods and systems for full and accurate quantification of practitioner production inputs, including the independent, collaborative and total medical services production inputs contributions of multiple practitioners.

### BACKGROUND

Medical Services Production

In microeconomic terms, medical services are produced by complex firms converting inputs into outputs by processing technologies. Inputs include available human resources and capital investments in facilities and technology. The processing technologies may be both complex and personalized. The outputs may be numerous, unpredictable, and occasionally critical. Medical services are economically important to both individuals and society, with growing demands suggesting future increases in both production demands and costs.

Factors such as increasing provider specialization, service complexity, the institutionalization of care and cost management efforts make it so that medical services are produced through the combined efforts of multiple practitioners. Not only are multiple physicians involved in producing care, there is increasing inclusion of mid-level practitioners such as nurse practitioners, midwives and physician assistants—offering the potential benefits of greater access, improved quality, higher patient satisfaction and increased affordability. These changing production strategies generate the need for methods and systems that accurately quantify these evolving medical services practitioner relationships.

Most current practitioner production data is developed for medical business systems, which are designed to accomplish the tasks related to generating payments for medical services. These systems are designed to meet objectives such as documenting clinical services, billing patients and payers, managing patient insurance information, or recording payer and patient reimbursements. Medical business data such as financial charges, or net collections, are frequently used as proxy measures for practitioner inputs and production; although such financial data may be related to practitioner efforts, these measures are affected by issues that seriously compromise both validity and utility as measures of practitioner inputs.

Because medical business systems are designed to meet payer's contract and claims submission requirements, these systems are not focused on practitioner production inputs. Medical business systems may fail to recognize the production contributions of some types of providers, credit practitioners with production that has been produced by other providers, or alternatively discredit practitioners for effort that was provided in support of other practitioners. Similarly, payers may credit only one physician for a service that involved the efforts of multiple providers.

Contractual arrangements between payers and providers add to production measurement difficulties. Many payers have provider compensation policies and procedures that are not consistent with contemporary medical services production processes. For example, a nurse practitioner may be qualified by license and experience to provide a service to a patient; however, different payers may have different contractual requirements. One payer contract may recognize the nurse practitioner as an independent provider, in which case the service supplied can be billed by the nurse practitioner, and fully credited as nurse practitioner effort; however, another payer may not recognize the nurse practitioner as an independent provider, but rather as a supplemental resource whose services are incidental to the services provided by the contracted physician. In this latter case, whatever services were supplied by the nurse practitioner (which may be valuable towards the production of the service) are ignored by the payer, and only the contracted physician's efforts are recognized by the payer—which usually indicates that all services rendered are credited to the contracted physician, regardless of the participation of other practitioners. In yet another variation, based upon the payer's contract, a nurse practitioner may provide the medical service, yet that service may be billed as having been performed by a physician if the physician was physically present in the physical location of service (ostensibly providing supervision) at the time of the service.

A fundamental shortcoming of the measures and systems currently employed to represent practitioner production is a failure to appreciate the significant level of multiple practitioner, collaborative effort occurring in the production of medical services. This inadequacy is sustained by medical business systems that are designed to meet payers' requirements, which lack concern about practitioner inputs, or multiple practitioner collaboration.

RVUs as Medical Services Production Inputs

In 1989 Congress authorized the creation of a national physician fee schedule for Medicare services. The Centers for Medicare and Medicaid Services subsequently instituted the Resource-Based Relative Value Scale (RBRVS) as the basis for Medicare fees on Jan. 1, 1992, with full implementation effective Jan. 1, 1996. The 2014 version of the RBRVS provides standardized resource input values for more than 13,000 physician services, along with national and regional Medicare pricing adjustment factors. Interim updates to the RBRVS values and fee adjustments are published at least annually in the Federal Register.

The RBRVS scale provides standardized values for distinct, resource-defined categories involved in the medical service production process. Services are defined by Current Procedural Terminology (CPT) codes. The standardized units of value assigned to represent resources are referred to as Relative Value Units (RVUs). The RBRVS scale is composed of three distinct RVU Components for each Service: Practitioner Work (MD_Work_RVUs), Practice Expense (Practice_RVUs) and Liability (Liability_RVUs). These RVU Components combine to produce a total for facility and non-facility service locations (Total_RVUs) for specific CPT-defined medical services. The representation of the RBRVS scale and RVU Components for a medical procedure is simplistically represented as follows:

MD_Work_RVUs+Practice_RVUs+Liability_RVUs=Total_RVUs

RVUs provide an excellent, standardized metric for representation of medical service production inputs. Arrays of procedure-specific services documented in the Enterprise's information systems can be transformed into arrays of production inputs through association with these RVU Component values.

### SUMMARY

This disclosure incorporates by reference all of the subject matter contained in U.S. Pat. No. 8,484,043 (U.S. patent application Ser. No. 11/525,090).

This disclosure provides methods and systems for quantification of Practitioner medical services production inputs, accounting for individual, collaborative and total efforts among multiple practitioners. Relative Value Units (RVUs) are used as measures for production inputs, Practitioners' production contributions are defined by Production Allocation Algorithms that represent the Practitioners' Independent Production Inputs, Collaborative Production Inputs and Total Production Inputs. The methods and systems produce quantifications of Practitioner production inputs that can be represented in various Reports, Tables and Graphs 50 with applicability to production, productivity, efficiency, compensation and similar measurements.

### BRIEF DESCRIPTION OF THE FIGURES

FIG. 1 provides Data Organization and Process for Quantification of Practitioner Medical Services Production Inputs.

FIG. 2 presents Total RVUs by Practitioner Excluding Consideration of Independent and Collaborative Production. FIG. 2 provides the results of the determinations of RVU Components MD_Work_RVUs, Practice_RVUs, Liability_RVUs and Total_RVUs, by Practitioner, for a specific multiple provider (i.e., multiple inputs) Production Activity File 10 excluding recognition of the Practitioners Independent Production Inputs and Collaborative Production Inputs activity. This Figure provides a basis for comparisons with FIGS. 3 and 4. Specifically, FIG. 2 represents a total of 48,065 MD_Work_RVUs inputs represented in the production of the medical services in the Production Activity File 10.

FIG. 3 presents Independent and Collaborative Production by Practitioner Including Consideration of Independent and Collaborative Production Inputs. FIG. 3 provides the results of the determination of Independent Production Inputs, Collaborative Production Inputs and Total Production Inputs for same RVU Components MD_Work_RVUs inputs by Practitioner for the same multiple input Production Activity File 10 as analyzed in FIG. 2. This analysis specifically includes the recognition of the Independent Production Effort and Collaborative Production Effort as accomplished by the aspects disclosed herein. The total MD_Work_RVUs were determined to be 48,064, essentially the same (within rounding error) as the determination in FIG. 2. Furthermore, FIG. 3 shows the Independent Production Input and Collaborative Production Input contributions for Practitioners by the MD_Work_RVUs represented in the horizontal table categories.

FIG. 4 presents Total MD Work RVUs by Practitioner Including Consideration of Independent and Collaborative Production Inputs. FIG. 4 provides Total MD Work RVUs by Practitioner with Consideration of Independent and Collaborative Production Inputs. FIG. 4 provides the Independent Production Inputs, Collaborative Production Inputs and Total Production Inputs for the RVU Components MD_Work_RVUs inputs by Practitioner for the same multiple input Production Activity File 10 as analyzed in FIGS. 2 and 3. The total MD_Work_RVUs represented in this calculation are 48,065. The comparisons of the MD_Work_RVUs inputs by Practitioner in FIG. 2 (excluding Independent and Collaborative production inputs) and FIG. 4 (including Independent and Collaborative production inputs) demonstrate material differences in Practitioners MD_Work_RVUs production inputs; these differences demonstrate the improved quantification of Practitioner medical services production inputs achieved by application of the aspects disclosed herein.

### DETAILED DESCRIPTION

### Definitions

Analytical Processing Unit 30

The Analytical Processing Unit 30 supplies the data management and analytical operations that apply the Production Allocation Algorithms to the Database, which contains the Production Activity File 10 data and RVU File 20 data. The results of Analytical Processing Unit 30 operations are represented in formats such as Reports, Tables and Graphs 50.

Collaborative Production Inputs/Efforts

Collaborative Production Inputs represent the Collaborator work effort contributions to the production of medical services. Collaborative Production Inputs are represented in terms of RVUs. Collaborative Production Inputs represent efforts for which the Collaborator acted in a supportive or secondary role, or for efforts for which the Collaborator did not receive payer financial credit. Collaborative Production Inputs may be one of multiple Practitioner inputs involved in the production of a Service.

Collaborator

Collaborator refers to a Practitioner who had a secondary or contributing role in the production of a Service. The designation of Collaborator is documented in the Production Activity File 10. The Production Allocation Algorithms credits the Collaborator with the Collaborative Production Inputs related to the production of the Service.

CPT

Current Procedural Terminology (CPT) are the labels, codes, descriptions and other data that are used to describe current medical procedures, as copyrighted (2014) by the American Medical Association.

Enterprise

An Enterprise can take a variety of different business and clinical forms. It may be convenient to envision the Enterprise as a medical practice; however, as used herein, the Enterprise can be any functional, medical services production entity. Enterprise data represents activities related to the production of medical Services.

Independent Production Inputs/Efforts

Independent Production Inputs represent the Practitioner's independent work effort contributions to the production of medical services. Independent Production Inputs are represented in terms of RVUs. Independent Production Inputs represent efforts for which the Practitioner acted as a major or primary Provider, or for efforts for which the Provider received payer financial credit. Independent Production Inputs may be one of multiple Practitioner inputs involved in the production of a Service.

Input

Input refers to a resource that is used in the medical services production process. In the current context, Inputs such as Practitioner's work effort, facilities, equipment and liability insurance coverage are combined through the Enterprise's operations to produce the outputs of medical services. The aspects disclosed herein provide for the quantification of multiple Practitioners' independent and collaborative inputs involved in the production of a Service.

Liability_RVUs

Liability_RVUs refers to the RBRVS RVU Components standardized RVU value that represents the medical liability resources associated with providing a specific medical service.

MD_Work_RVUs

MD_Work_RVUs refers to the RBRVS RVU Components standardized RVU value that represents the Practitioner resources associated with providing a specific medical service.

Multiple Input Production

Multiple Input Production refers to a production process that involves multiple inputs. A physician working in collaboration with a nurse practitioner would be an example of Multiple Input Production. The aspects disclosed herein provide a method and process for quantification of Practitioner inputs in a Multiple Input Production medical Services production process.

Practitioner

A Practitioner is a medical services provider who has contributed effort to the production of the Services. The Practitioner's inclusion in the production of the service is documented in the Enterprise's Production Activity File 10. A Practitioner can supply either Independent Production Inputs or Collaborative Production Inputs, which are credited in accordance with the Production Allocation Algorithms applied by the Analytical Processing Unit 30.

Production Activity Data

Production Activity Data are stored in the Production Activity File 10. These Service-specific, Practitioner-specific data are frequently obtained from the Enterprise's business information systems. Production Activity Data provide detailed information about the medical services produced by an Enterprise. For each Service produced during the Reference Period, Production Activity Data could include data such as Procedure Code, Modifier, Date of Service, Location of Service, Provider, Collaborator and Payer, or other Service-specific, Practitioner-specific data.

Production Activity File 10

The Production Activity File 10 contains the data elements that document the Services provided by the Enterprise during the Reference Period. The Production Activity File 10 contains information that describes both the specific medical services produced and the roles of Practitioners in the production of each Service. For each Service produced during the Reference Period, Production Activity Data could include data such as Procedure Code, Modifier, Date of Service, Location of Service, Provider, Collaborator and Payer, or other Service-specific, Practitioner-specific data.

Production Allocation Algorithms

Production Allocation Algorithms are a part of the Analytical Processing Unit 30. The algorithms are a set of Enterprise-defined processes or rules that are utilized, in conjunction with the Practitioner data in the Database, to allocate Independent Production Inputs and Collaborative Production Inputs among Practitioners. Production Allocation Algorithms operate in accordance with the multiple Practitioner inputs data contained in the Production Activity File 10, such as Provider, Collaborator, Payer, or other useful production indicators.

Provider

Provider is a label that refers to a Practitioner who has a major or lead role in supplying a Service, or who will be financially credited for providing the Service by the Payer. The designation of Provider is documented in the Production Activity File 10. The Production Allocation Algorithms credits the Provider with the Independent Production Inputs and Collaborative Production Inputs related to the production of the Service.

RBRVS

The Resource Based Relative Value Scale (RBRVS) is part of the Medicare medical procedure payment system developed and supported by the Centers for Medicare and Medicaid Services (CMS). The RBRVS provides standardized, Relative Value Unit (RVU) weights indicating the relative amounts of resources required for the production of more than 13,000 medical services. The RBRVS represents a medical service quantitatively as an additive combination of three RVU Components—each represented by RVU weights: MD_Work_RVUs (a measure of the Practitioner's work effort), Practice_RVUs (a measure of the cost of overhead such as supplies, support staff and rent) and Liability_RVUs (a measure of professional liability insurance expense). These three RVU Components are added together to constitute Total RVUs for a specific medical service, which indicates the total, standardized, relative resources required for the production of that specific medical service.

Reference Period

Enterprise Production Activity Data are typically obtained for Services rendered during a designated timeframe, referred to as the Reference Period. The Reference Period is oftentimes a twelve month period of activity corresponding to the Enterprise's financial reporting period; however, the Reference Period can be any period of operations for which Production Activity Data exist.

RVU

A Relative Value Unit (RVU) is the standardized unit of measure that is assigned to a medical Service as a part of the RBRVS. The RBRVS represents a medical service quantitatively as an additive combination of three RVU Components—each represented by RVU weights: MD_Work_RVUs (a measure of the Practitioner's work effort), Practice_RVUs (a measure of the cost of overhead such as supplies, support staff and rent) and Liability_RVUs (a measure of professional liability insurance expense). These three RVU Components are added together to constitute Total RVUs for a specific medical service, which indicates the total, standardized, relative resources required for the production of that specific medical service.

RVU Components

The RBRVS represents medical service production as requiring three types of resources—Practitioner, Practice and Medical Liability—with standardized RVUs representing the relative values of each of these resources. RVU Components refers to these three types of medical services production inputs, which are herein labeled as MD_Work_RVUs, Practice_RVUs and Liability_RVUs.

RVU File 20

The RVU File 20 contains the RVU values (e.g., MD_Work_RVUs, Practice_RVUs and Liability_RVUs) from the RBRVS that correspond to the Services contained in the Production Activity File 10, and to the RVU Year for the specific Reference Period under consideration.

RVU Year

The RVRVS is updated at least annually by CMS. RVU Year refers to the RBRVS tables published by CMS for utilization regarding a designated period of medical services production activity.

Service

Each unique, CPT-identified medical service, or similarly documented medical procedure, is considered a Service. Services data are frequently obtained from the Enterprise's business information systems, and are stored in the Production Activity File 10. Typical Service data includes information such as CPT-defined Procedure, Modifier, Location of Service, Date of Service, or any other data useful in describing the specific service produced.

Total Production Inputs/Effort

Total Production Inputs is the combination of the Independent Production Inputs and Collaborative Production Inputs supplied by a Practitioner in the production of a medical Service. Total Production Inputs are represented in term of RVUs.

Total_RVUs

Total_RVUs is the sum of the RBRVS RVU Components herein labeled as MD_Work_RVUs, Practice_RVUs and Liability_RVUs. Total_RVUs represents the total resource Inputs, expressed in standardized RVUs, determined to be associated with the production of a medical service.

Data Elements and Processes

RVU Data

The RBRVS quantifies the resources consumed in the production of medical services in terms of standardized RVUs. Accurate quantification of the production inputs for a specific Reference Period requires the inclusion of all clinical services produced by the Enterprise for which RVU values exist, or have been created. CMS generally does not provide RVUs for Procedure Codes with Modifiers. Accuracy is improved by the inclusion of Modifiers, and Location of Service as determinants of RVU Practice Expense resource values; excluding significant numbers of valid procedures from consideration, failing to properly adjust for Modifiers, or ignoring the Location of Service will adversely impact the quantification of production inputs.

The aspects disclosed herein provide control over the RVU values assigned to Services produced during the Reference Period based on the following attributes, such as the following: Procedure Code, Modifier, Location of Service and RVU Year. The aspects disclosed herein utilize the methods and systems for determination of adjusted RVU values described by Brookhart (2006). These procedure-specific, location-specific, modifier-adjusted RVU values for the designated RVU Year are stored in the RVU File 20.

Utilizing a system of hardware and software, the Production Activity File 10 and the RVU File 20 are combined into a common Database which may be accessed by the Analytical Processing Unit 30. RVU data are obtained for the Reference Period RVU Year from the appropriate RBRVS tables published in the Federal Register by the Centers for Medicare and Medicaid Services. RVU values are obtained by CPT code for MD_Work_RVUs, Practice_RVUs (both facility and non-facility), Liability_RVUs and Total_RVUs (both facility and non-facility). The unique Procedure Code and Modifier combinations of Modifier-adjusted RVU values are included as a part of the RVU File 20, associated with the Enterprise's Reference Period Production Activity File 10 data, and stored in the Database. The Analytical Processing Unit 30 applies unique Production Allocation Algorithms that define the multiple Practitioner production relationships, which may relate to such attributes as Provider, Collaborator, Payer, Location of Service, or any other included variable or relationship among variables. The results of the Analytical Processing Unit 30 operations can be represented in various Reports, Tables and Graphs 50.

Production Activity Data

Production Activity Data consist of procedure-specific data for Services performed by the Enterprise during the Reference Period. These data are typically collected and retained in the Enterprise's medical business system in the format of CPT codes and related provider and billing information, although unique, Enterprise-created codes are sometimes included to describe additional services. In one typical situation, the Enterprise may export a standardized-format data file from its billing system containing the required Production Activity Data for the Reference Period. The Production Activity Data are comprised of data elements, such as the following, for each Service produced during the Reference Period Procedure Code, Modifier, Location of Service; Provider, Collaborator, Payer, Date of Service, or other relevant descriptors of Services. In one embodiment, a data element indicating Collaborator is collected which identifies the collaborative participation of the Practitioner in the production of the Service. The Production Activity Data are stored in the Production Activity File 10, associated with the data in the RVU File 20, stored in the Database, and accessed by the Analytical Processing Unit 30.

Production Allocation Algorithms

The aspects disclosed herein utilize Production Allocation Algorithms to credit the RVU resource inputs to the multiple participating Practitioners involved in the production of Services. The algorithms are stored in the Analytical Processing Unit 30 and operate upon the data in the Database. These algorithms can apply to any of the RVU Components (MD_Work_RVUs, Practice_RVUs, and Liability_RVUs), and to Total_RVUs.

Production Activity File 10 elements such as Provider, Collaborator and Payer provide explicit and implicit information about a Practitioner's role in the production of a specific Service. The following are examples of explicit and implicit multiple Practitioner information, and the possible applications of that information through the Production Allocation Algorithms:

If, based upon Production Activity File 10 data, Provider=“Adams” and Collaborator=“Adams” or “No Collaborator” (i.e., No Collaborator was involved in the Service production) then, per the Production Allocation Algorithms, Practitioner “Adams” receives credit for 100% of the RVUs attributed to that Service and is understood to be the major Practitioner resource involved in the production of the service;

If, based upon Production Activity File 10 data, Provider=“Adams” and Collaborator=“Baker” (i.e., a different Practitioner was involved in the production), then, per the Production Allocation Algorithms, Practitioner “Adams” receives credit for the Independent Production Effort supplied (such as 75% of the RVUs attributed to that Service); Practitioner “Baker” receives credit for the Collaborative Production Effort contributed (such as 25% of the RVUs attributed to that Service);

Payers may have rules about the provision of services that apply specifically to their beneficiaries: For example, a payer may allow a Practitioner to be credited for the on-site supervision of another practitioner's (e.g., nurse practitioner) services. For a specific payer, the indication of a Collaborative Practitioner for a Service in the Data Activity File can convey information about the Practitioners' roles in the production of that Service. For example, if the payer is Medicare and a nurse practitioner is identified as a Collaborator, and not Provider, then it is inferred that the nurse practitioner actually provided the service and the Provider supplied on-site supervision services as required by Medicare's rules. The Production Allocation Algorithm may credit the Provider with some portion of the Service (e.g., 25% of the RVUs) for this supervisory role, while the Collaborator may receive credit (e.g., 75% of the RVUs) for the actual production of the Service.

Independent, Collaborative and Total Production Inputs

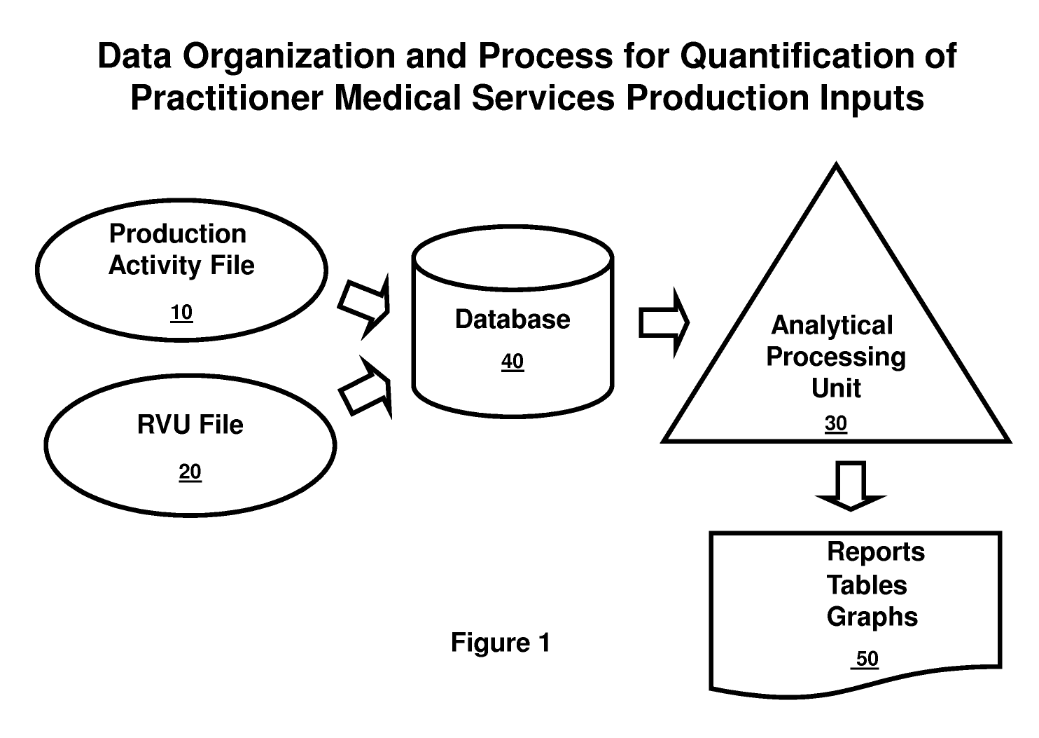

The major data components and functional relationships are presented in FIG. 1, Data Organization and Process for Quantification of Practitioner Medical Services Production Inputs. The Production Activity File 10 contains information related to the medical services produced by an Enterprise during a Reference Period. The Production Activity File 10 contains data, such as Procedure Code, Modifier, Location of Service, Payer, Date of Service, Provider and Collaborator. Additionally, the Production Activity File 10 contains the data elements that indicate the Independent Production Inputs and Collaborative Production Inputs of the Practitioners involved in the production of each Service.

Also presented in FIG. 1, the RVU File 20 contains procedure specific, location specific and modifier-adjusted RVU values associated with the Services specified in the Production Activity File 10. These procedure-specific, location-specific, modifier-adjusted RVU values are determined for each of the RVU Components (MD_Work_RVUs, Practice_RVUs and Liability_RVUs) and for Total_RVUs.

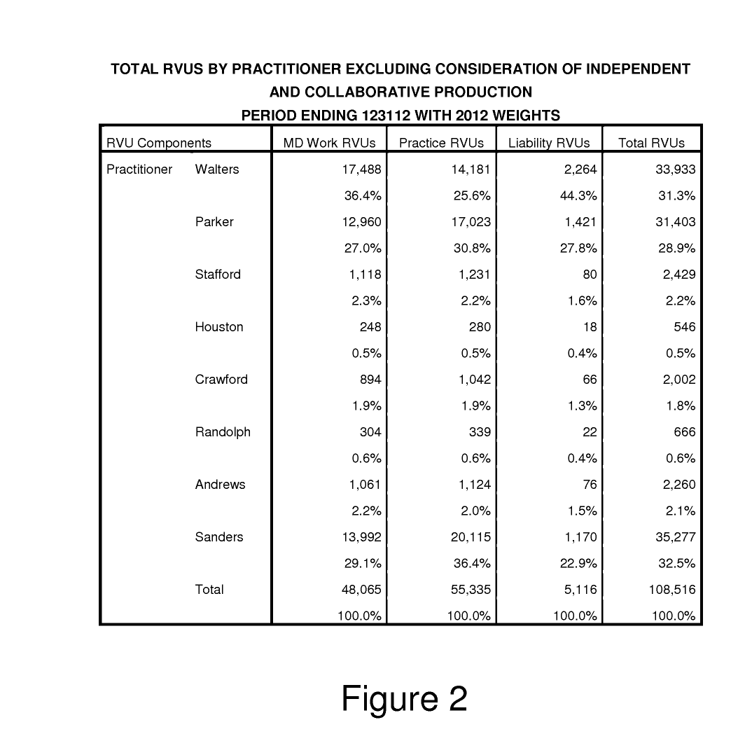

Utilizing a system of hardware and software that associates each Service with the corresponding RVU Components values, the Production Activity File 10 is associated with corresponding data in the RVU File 20 are combined into a common Database. The Analytical Processing Unit 30 applies the Production Allocation Algorithms, which define the Practitioner Independent Production Inputs and Collaborative Production Inputs for each Service, based upon Database data such as Provider, Collaborator, Payer, Procedure Code, Location of Service, or any other included variable or relationship among variables. The results of the Analytical Processing Unit 30 operations are presented in Reports, Tables, Graphs, or other similar expressions such as those examples provided in FIGS. 2, 3 and 4.

In one embodiment, the results of Analytical Processing Unit 30 operations are represented in FIGS. 2, 3 and 4 for a group of Practitioners that includes both physicians and nurse practitioners, and who sometimes work independently and at other times work collaboratively. A Practitioner's contribution to the production of a Service can be represented as either Independent Production Inputs (i.e., Practitioner was the primary, or major practitioner involved in the production of the Service) or Collaborative Production Inputs (i.e., Practitioner was a secondary, or supporting practitioner, involved in the production of the Service); A Practitioner's Total Production Inputs are represented by the sum of the Practitioner's Independent Production Inputs and Collaborative Production Inputs.

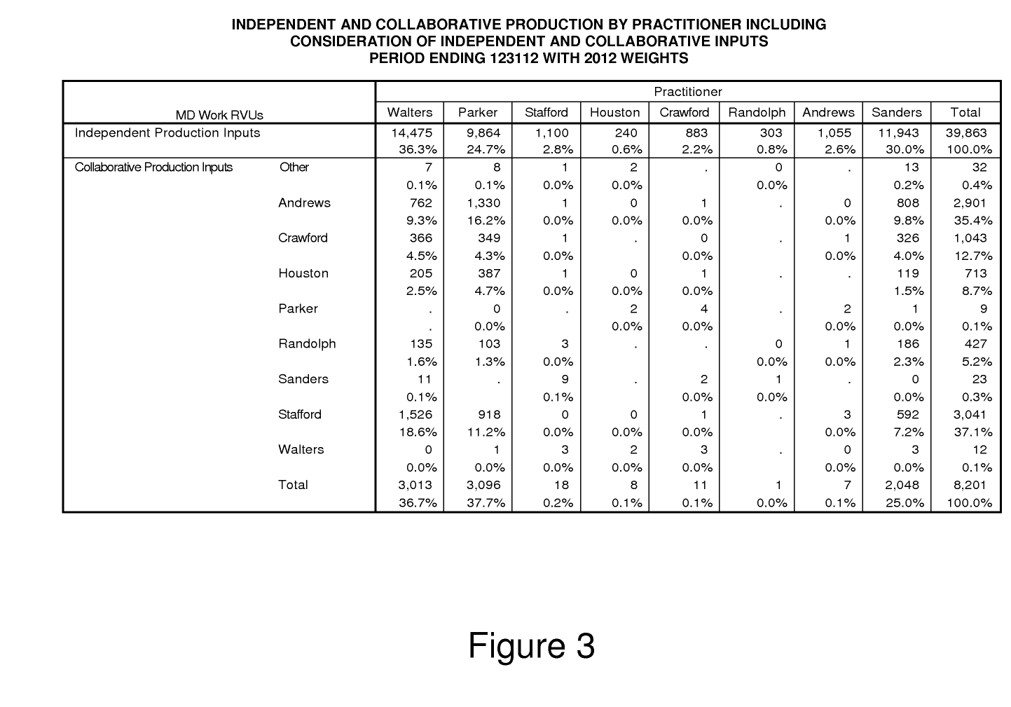

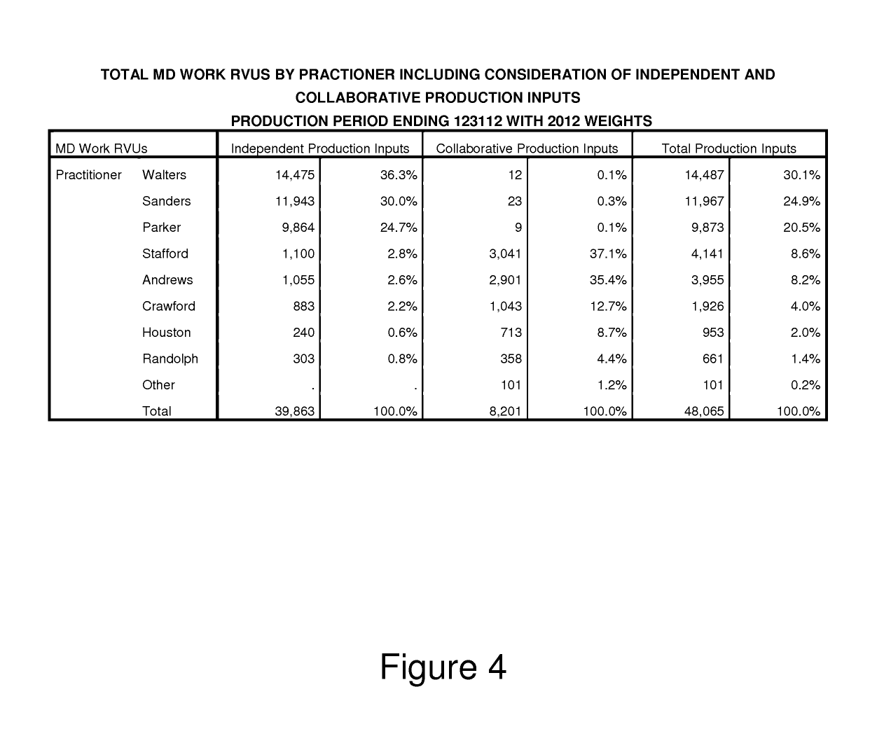

FIGS. 3 and 4 present the results of the application of the Analytical Processing Unit 30 to the Database for the RVU Component of MD_Work_RVUs. The application of the Production Allocation Algorithms to the MD_Work_RVUs determines the Practitioners' individual work contributions—both independently and collaboratively—to the production of the medical Services. These same Production Allocation Algorithms can be applied to the RVU Components of Practice_RVUs, Liability_RVUs and Total_RVUs, which would indicate the Practitioners' Independent Production Inputs and Collaborative Production Inputs contributions to the practice, liability and total resources utilized in the production of the Services under consideration.

Although Independent Production Inputs and Collaborative Production Inputs can be quantified for any RVU Component, the effects of these quantifications on the RVU Component of MD_Work_RVUs is demonstrated by the comparisons between FIG. 2 (determination of MD_Work_RVUs by Practitioner excluding Independent and Collaborative inputs quantification) and FIGS. 3 and 4 (determination of MD_Work_RVUs by Practitioner including Independent and Collaborative inputs quantification).

FIG. 2 presents Total RVUs by Practitioner Excluding Consideration of Independent and Collaborative Production. Practitioner production is represented by the calculation of procedure-specific, location-specific, modifier-adjusted MD_Work_RVUs, Practice_RVUs, Liability_RVUs and Total_RVUs excluding consideration of Independent Production Inputs and Collaborative Production Inputs effects. FIG. 2 indicates that a total of 48,065 MD_Work_RVUs were produced by the practitioners. As Specifically presented in FIG. 2, excluding consideration of Independent Production Inputs and Collaborative Production Inputs production activity effects, Practitioner Walters is credited with the production inputs of 17,488 MD_Work_RVUs, and Practitioner Andrews is credited with the production inputs of 1,061 MD_Work_RVUs.

FIG. 3 utilizes the same Production Activity File 10 as used in FIG. 2, but includes consideration of Independent Production Inputs and Collaborative Production Inputs of the Practitioners by application of the Production Allocation Algorithms in the Analytical Processing Unit 30. The Practitioners' Independent Production Inputs and Collaborative Production Inputs contributions of Practitioner resources (MD_Work_RVUs) are presented in FIGS. 3 and 4.

FIG. 3 presents, Independent and Collaborative Production by Practitioner Including Consideration of Independent and Collaborative Production Inputs. FIG. 3 provides the results of the determination of Independent Production Inputs, Collaborative Production Inputs and Total Production Inputs for same RVU Components MD_Work_RVUs inputs by Practitioner for the same multiple input Production Activity File 10 as analyzed in FIG. 2. The production input quantifications in FIG. 3 include the recognition of the Independent Production Effort and Collaborative Production Effort as accomplished by the elements shown in FIG. 1. Specifically, Practitioner Walters is credited with Independent Production Inputs of 14,475 MD_Work_RVUs; Practitioner Andrews is credited with Independent Production Inputs of 1,055 MD_Work_RVUs. Furthermore, FIG. 3 indicates that Practitioner Walters supplied a total of 12 MD_Work_RVUs in Collaborative Production Inputs support for other Practitioners, and Practitioner Andrews provided 2,901 MD_Work_RVUs in Collaborative Production Inputs support to other Practitioners. Specifically, Practitioner Andrews provided 762 MD_Work_RVUs in collaborative support of Walters; 1,330 MD_Work_RVUs in collaborative support of Parker; 1 MD_Work_RVUs in collaborative support of Stafford; 1 MD_Work_RVUs in collaborative support of Crawford; and 808 MD_Work_RVUs in collaborative support of Sanders. Similar interpretations can be made for Independent Production Inputs and Collaborative Production Inputs represented for the other Practitioners.

FIG. 4 presents Total MD Work RVUs by Practitioner Including Consideration of Independent and Collaborative Production Inputs. FIG. 4 provides the Independent Production Inputs, Collaborative Production Inputs and Total Production Inputs for the RVU Components MD_Work_RVUs inputs by Practitioner for the same multiple input Production Activity File 10 as analyzed in FIGS. 2 and 3. The total MD_Work_RVUs represented in this calculation are 48,065. When Independent Production Inputs and Collaborative Production Inputs contributions are taken into account, Practitioner Walter's Total Production Inputs is determined to be 14,487 MD_Work_RVUs (rather than 17,488 MD_Work_RVUs as represented in FIG. 2), and Practitioner Andrew's Total Production Inputs is determined to be 3,955 MD_Work_RVUs (rather than 1,061 MD_Work_RVUs as represented in FIG. 2). The considerations of Independent Production Inputs and Collaborative Production Inputs demonstrate material differences in quantifications of Practitioner MD_Work_RVUs production inputs versus the aspects disclosed herein.

Quantification of Practitioner Production Inputs

1 A Process for Quantification of Practitioner Independent Production Inputs

The aspects disclosed herein provide a process for the quantification of Practitioner Independent Production Inputs to medical services production. A typical quantification of Practitioner Independent Production Inputs begins with the determination of procedure-specific, location-specific, modifier-adjusted RVUs associated with the Services produced by a Practitioner during the Reference Period based upon the activity documented in the Enterprise's Production Activity File 10. The Practitioner Independent Production Inputs generated by the Practitioner is determined by applying the Production Allocation Algorithms to these adjusted RVUs quantities.

In one embodiment, the quantification of the Practitioner Independent Production Inputs is the sum of the cross products of Practitioner Production Allocation Algorithms Provider values and MD_Work_RVUs for all Services rendered by the Enterprise during the Reference Period, and represents quantification of Practitioner Independent Production Inputs for the Reference Period.

2 A Process for Quantification of Practitioner Collaborative Production Inputs

The aspects disclosed herein provide a process for the quantification of Practitioner Collaborative Production Inputs to medical services production. A typical quantification of Practitioner Collaborative Production Inputs begins with the determination of procedure-specific, location-specific, modifier-adjusted RVUs associated with the Services produced by a Practitioner during the Reference Period based upon the activity documented in the Enterprise's Production Activity File 10. The Practitioner Collaborative Production Inputs generated by the Practitioner is determined by applying the Production Allocation Algorithms to these adjusted RVUs quantities.

In one embodiment, the quantification of the Practitioner's Collaborative Production Inputs is the sum of the cross products of Practitioner Production Allocation Algorithms Collaborator values and MD Work RVUs for all Services rendered by the Enterprise during the Reference Period, and represents quantification of Practitioner Collaborative Production Inputs for Reference Period.

3 A Process for Quantification of Practitioner Total Independent and Collaborative Production Inputs

The aspects disclosed herein provide a process for the quantification of Practitioner Total Independent and Collaborative Production Inputs to medical services production. A typical quantification of Practitioner Total Independent and Collaborative Production Inputs begins with the determination of procedure-specific, location-specific, modifier-adjusted RVUs associated with the Services produced by a Practitioner during the Reference Period based upon the activity documented in the Enterprise's Production Activity File 10. The Practitioner Total Independent and Collaborative Production Inputs generated by the Practitioner are determined by applying the Production Allocation Algorithms to these adjusted RVUs quantities.

In one embodiment, the quantification of the Practitioner's Total Independent and Collaborative Production Inputs is the combined summations of cross products of Practitioner Production Allocation Algorithms Provider and Collaborator values with MD_Work_RVUs for all Services rendered by the Enterprise during the Reference Period, and represents quantification of Practitioner Total Independent and Collaborative Production Inputs for the Reference Period.

Quantification of Practitioner Practice Resource Inputs

4 A Process for Quantification of Practitioner Independent Practice Resource Inputs

The aspects disclosed herein provide a process for the quantification of Practitioner Independent Practice Resource Inputs to medical services production. A typical quantification of Practitioner Independent Practice Resource Inputs begins with the determination of procedure-specific, location-specific, modifier-adjusted RVUs associated with the Services produced by a Practitioner during the Reference Period based upon the activity documented in the Enterprise's Production Activity File 10. The Practitioner Independent Practice Resource Inputs generated by the Practitioner is determined by applying the Production Allocation Algorithms to these adjusted RVUs quantities.

In one embodiment, the quantification of the Practitioner Independent Practice Resource Inputs is the sum of the cross products of Practitioner Production Allocation Algorithms Provider values and Practice_RVUs for all Services rendered by the Enterprise during the Reference Period, and represents quantification of Practitioner Independent Practice Resource Inputs for the Reference Period.

5 A Process for Quantification of Practitioner Collaborative Practice Resource Inputs

The aspects disclosed herein provide a process for the quantification of Practitioner Collaborative Practice Resource Inputs to medical services production. A typical quantification of Practitioner Collaborative Practice Resource Inputs begins with the determination of procedure-specific, location-specific, modifier-adjusted RVUs associated with the Services produced by a Practitioner during the Reference Period based upon the activity documented in the Enterprise's Production Activity File 10. The Practitioner Collaborative Practice Resource Inputs generated by the Practitioner is determined by applying the Production Allocation Algorithms to these adjusted RVUs quantities.

In one embodiment, the quantification of the Practitioner's Collaborative Practice Resource Inputs is the sum of the cross products of Practitioner Production Allocation Algorithms Collaborator values and Practice_RVUs for all Services rendered by the Enterprise during the Reference Period, and represents quantification of Practitioner Collaborative Practice Resource Inputs for Reference Period.

6 A Process for Quantification of Practitioner Total Independent and Collaborative Practice Resource Inputs

The aspects disclosed herein provide a process for the quantification of Practitioner Total Independent and Collaborative Practice Resource Inputs to medical services production. A typical quantification of Practitioner Total Independent and Collaborative Practice Resource Inputs begins with the determination of procedure-specific, location-specific, modifier-adjusted RVUs associated with the Services produced by a Practitioner during the Reference Period based upon the activity documented in the Enterprise's Production Activity File 10. The Practitioner Total Independent and Collaborative Practice Resource Inputs generated by the Practitioner are determined by applying the Production Allocation Algorithms to these adjusted RVUs quantities.

In one embodiment, the quantification of the Practitioner's Total Independent and Collaborative Practice Resource Inputs is the combined summations of cross products of Practitioner Production Allocation Algorithms Provider and Collaborator values with Practice_RVUs for all Services rendered by the Enterprise during the Reference Period, and represents quantification of Practitioner Total Independent and Collaborative Practice Resource Inputs for the Reference Period.

Quantification of Practitioner Liability Resource Inputs

7 A Process for Quantification of Practitioner Independent Liability Resource Inputs

The aspects disclosed herein provide a process for the quantification of Practitioner Independent Liability Inputs to medical services production. A typical quantification of Practitioner Independent Liability Inputs begins with the determination of procedure-specific, location-specific, modifier-adjusted RVUs associated with the Services produced by a Practitioner during the Reference Period based upon the activity documented in the Enterprise's Production Activity File 10. The Practitioner Independent Liability Inputs generated by the Practitioner is determined by applying the Production Allocation Algorithms to these adjusted RVUs quantities.

In one embodiment, the quantification of the Practitioner Independent Liability Inputs is the sum of the cross products of Practitioner Production Allocation Algorithms Provider values and Liability_RVUs for all Services rendered by the Enterprise during the Reference Period, and represents quantification of Practitioner Independent Liability Inputs for the Reference Period.

8 A Process for Quantification of Practitioner Collaborative Liability Resource Inputs

The aspects disclosed herein provide a process for the quantification of Practitioner Collaborative Liability Resource Inputs to medical services production, A typical quantification of Practitioner Collaborative Liability Resource Inputs begins with the determination of procedure-specific, location-specific, modifier-adjusted RVUs associated with the Services produced by a Practitioner during the Reference Period based upon the activity documented in the Enterprise's Production Activity File 10. The Practitioner Collaborative Liability Resource Inputs generated by the Practitioner is determined by applying the Production Allocation Algorithms to these adjusted RVUs quantities.

In one embodiment, the quantification of the Practitioner's Collaborative Liability Resource Inputs is the sum of the cross products of Practitioner Production Allocation Algorithms Collaborator values and Liability_RVUs for all Services rendered by the Enterprise during the Reference Period, and represents quantification of Practitioner Collaborative Liability Resource Inputs for Reference Period.

9 A Process for Quantification of Practitioner Total Independent and Collaborative Liability Resource Inputs

The aspects disclosed herein provide a process for the quantification of Practitioner Total Independent and Collaborative Liability Resource Inputs to medical services production. A typical quantification of Practitioner Total Independent and Collaborative Liability Resource Inputs begins with the determination of procedure-specific, location-specific, modifier-adjusted RVUs associated with the Services produced by a Practitioner during the Reference Period based upon the activity documented in the Enterprise's Production Activity File 10. The Practitioner Total Independent and Collaborative Liability Resource Inputs generated by the Practitioner are determined by applying the Production Allocation Algorithms to these adjusted RVUs quantities.

In one embodiment, the quantification of the Practitioner's Total Independent and Collaborative Liability Resource Inputs is the combined summations of cross products of Practitioner Production Allocation Algorithms Provider and Collaborator values with Liability_RVUs for all Services rendered by the Enterprise during the Reference Period, and represents quantification of Practitioner Total Independent and Collaborative Liability Resource Inputs for the Reference Period.

Quantification of Practitioner Total Inputs

10 A Process for Quantification of Practitioner Total Independent Production, Practice and Liability Resource Inputs

The aspects disclosed herein provide a process for the quantification of Practitioner Total Independent Production, Practice and Liability Resource Inputs to medical services production. A typical quantification of Practitioner Total Independent Production, Practice and Liability Resource Inputs begins with the determination of procedure-specific, location-specific, modifier-adjusted RVUs associated with the Services produced by a Practitioner during the Reference Period based upon the activity documented in the Enterprise's Production Activity File 10. The Practitioner Total Independent Production, Practice and Liability Resource Inputs generated by the Practitioner are determined by applying the Production Allocation Algorithms to these adjusted RVUs quantities.

In one embodiment, the quantification of the Practitioner Total Independent Production, Practice and Liability Resource Inputs is the sum of the cross product of Practitioner Production Allocation Algorithms Provider values with MD_Work_RVUs, Practice_RVUs and Liability_RVUs for all Services rendered by the Enterprise during the Reference Period, and represents quantification of Practitioner Total Independent Production, Practice and Liability Resource Inputs for the Reference Period.

11. A Process for Quantification of Practitioner Total Collaborative Production, Practice and Liability Resource Inputs

The aspects disclosed herein provide a process for the quantification of Practitioner Total Collaborative Production, Practice and Liability Resource Inputs to medical services production. A typical quantification of Practitioner Total Collaborative Production, Practice and Liability Resource Inputs begins with the determination of procedure-specific, location-specific, modifier-adjusted RVUs associated with the Services produced by a Practitioner during the Reference Period based upon the activity documented in the Enterprise's Production Activity File 10. The Practitioner Total Collaborative Production, Practice and Liability Resource Inputs generated by the Practitioner are determined by applying the Production Allocation Algorithms to these adjusted RVUs quantities.

In one embodiment, the quantification of the Practitioner Total Collaborative Production, Practice and Liability Resource Inputs is the sum of the cross product of Practitioner Production Allocation Algorithms Collaborator values with MD_Work_RVUs, Practice_RVUs and Liability_RVUs for all Services rendered by the Enterprise during the Reference Period, and represents quantification of Practitioner Total Collaborative Production, Practice and Liability Resource Inputs for the Reference Period.

12. A Process for Quantification of Practitioner Total Independent and Collaborative Production, Practice and Liability Resource Inputs

The aspects disclosed herein provide a process for the quantification of Practitioner Total Independent and Collaborative Production, Practice and Liability Resource Inputs to medical services production. A typical quantification of Practitioner Total Independent and Collaborative Production, Practice and Liability Resource Inputs begins with the determination of procedure-specific, location-specific, modifier-adjusted RVUs associated with the Services produced by a Practitioner during the Reference Period based upon the activity documented in the Enterprise's Production Activity File 10. The Practitioner Total Independent and Collaborative Production, Practice and Liability Resource Inputs generated by the Practitioner are determined by applying the Production Allocation Algorithms to these adjusted RVUs quantities.

In one embodiment, the quantification of the Practitioner Total Independent and Collaborative Production, Practice and Liability Resource Inputs is the summation of the cross products of Practitioner Production Allocation Algorithms Provider and Collaborator values with MD_Work_RVUs, Practice_RVUs and Liability_RVUs for all Services rendered by the Enterprise during the Reference Period, and represents quantification of Practitioner Total Independent and Collaborative Production, Practice and Liability Resource Inputs for the Reference Period.

Data Management, Data Analysis and Reporting

13. A Process for Data Management and Data Analysis for Quantification of Practitioner Medical Services Production Inputs

The aspects disclosed herein provide a process for data management and data analysis for quantification of Practitioner medical services production inputs. These processes are performed by hardware and software supported systems that direct the data storage, data management and data analysis operations. The data management processes include management of the Patient Activity Data in the Patient Activity File; management of the RVU Data in the RVU File 20; management of the associated Patient Activity data and RVU Data in the Database. The data analysis processes include the analyses performed by the Analytical Processing Unit 30, including application of the Production Allocation Algorithms.

14 A Process for Reporting the Quantification of Practitioner Medical Services Production Inputs

The aspects disclosed herein provide a process for production of Reports, Tables, Graphs and other representations of the quantification of Practitioner medical services production inputs. Reports, Tables and Graphs 50 present the results of the analyses in numerous meaningful formats and aggregations including, but not limited to, the following: Reports, Tables and Graphs 50 of Input RVU Components by Practitioner; Reports, Tables and Graphs 50 of Independent Production Inputs and Collaborative Production Inputs by Practitioner; and Reports, Tables and Graphs 50 of Total Independent Production Inputs and Total Collaborative Production Inputs by Practitioner. Titles, Labels, Names and other information are included in Tables, Reports and Graphs for clarification and enhanced readability.

What is claimed is the following:

1. A method of analyzing medical procedure activity-based costing and margin, the method comprising:
calculating, using a computing device, Relative Value Units (RVUs) stored in a common database by including all valid services in a determination of medical practice outputs;
providing a selection of RVU weights from Centers for Medicare and Medicaid Services (CMS)-published RVU weight tables, stored in the common database, including Location of Service as an attribute of output;
associating a performed medical procedure with at least one of the RVUs;
associating a performed medical procedure by one of the contributors to the at least one of the RVUs;
modifying the at least one of the RVUs in accordance with the performed medical procedure to produce a modifier-adjusted (PLM) RVU value; and
calculating a PLM service product cost based on the PLM RVU value and a service product cost during a predetermined reference period.

2. A method of analyzing medical procedure activity-based costing and margin, the method comprising:
creating an Activity File, and RVU File 20, and a Payer Fee file and storing the files into a common database;
analyzing the files stored in the common database with a computer processor using input from financial data;
outputting an analysis in a predetermined table or graph;
associating a performed medical procedure with at least one of the RVUs;
associating a performed medical procedure by one of the contributors to the at least one of the RVUs;
modifying the at least one of the RVUs in accordance with the performed medical procedure to produce a modifier-adjusted (PLM) RVU value; and
calculating a PLM service product cost based on the PLM RVU value and a service product cost during a predetermined reference period,
wherein the service product cost is a calculated cost of the performed medical procedure,
the location of service defines that the medical procedure was performed at a facility or a non-facility location, and
the RVUs, the PLM RVU value are modifier-adjusted, product-specific and location-specific.

3. The method of claim 2, wherein said Activity File are for a designated Reference Period.

4. The method of claim 2, wherein said RVU File 20 comprises RVU weights data.

5. The method of claim 4, wherein said RVU weights in said data comprises weights for procedures with valid modifiers or no modifiers.

6. The method of claim 5, wherein said valid modifier's weight are selected from the list comprising CMS reimbursement practices, practice's Payer-specific reimbursement experience, payer-mix weighted value, and practice studied determination of its procedure Modifier costs.

7. The method of claim 4, wherein said weights data are based on Procedure Code, Modifier, Location of Service, and RVU File 20.

8. The method of claim 2, wherein the Payer Fee File is based on Payer Fee Schedules.

9. The method of claim 8, wherein said Payer Fee Schedules are based on differences in geographic location, service coverage, enrollment group utilization experience, or market strategy.

10. The method of claim 2, wherein said Process Module uses said Financial Data to calculate Adjusted Total Operating Costs and Adjusted Total Collections.

11. The method of claim 10, wherein said Adjusted Total Operating Costs is Total Operating Costs (C)−Exceptional Physician Compensation (Q)−Costs not Represented (R)−Non-Reference Period Costs Recognized (U)+Reference Period Costs Not Recognized (V).

12. The method according to claim 1, wherein the service product cost is a calculated cost of the performed medical procedure,
the location of service defines that the medical procedure was performed at a facility or a non-facility location, and
the RVUs, the PLM RVU value are modifier-adjusted, product-specific and location-specific.

13. The method according to claim 2, wherein the service product cost is a calculated cost of the performed medical procedure,
the location of service defines that the medical procedure was performed at a facility or a non-facility location, and
the RVUs, the PLM RVU value are modifier-adjusted, product-specific and location-specific.
